(19) United States
(12) Patent Application Publication
(10) Pub. No.: US 2011/0231334 A1
(43) Pub. Date: Sep. 22, 2011

(54) Parcel delivery system and method

(76) Inventor: Satish Jindel, Sewickley, PA (US)

(21) Appl. No.: 13/053,512

(22) Filed: Mar. 22, 2011

Related U.S. Application Data
(60) Provisional application No. 61/316,066, filed on Mar. 22, 2010.

(51) Int. Cl. G06Q 30/00

(52) U.S. Cl. 705/335

(57) ABSTRACT

A system and method for providing a shipper with a carrier service based on mix and match of transit days and times for better matching of shipper's needs with carriers' services. The shipper inputs origin and destination, wherein distance is calculated between origin and destination zip codes and a zone is assigned corresponding to transit days. The shipper is then presented with options and cost to ship based on transit days. Shipper makes the decision and the computer presents the shipper with options and cost for delivery time based on the distance from carrier's facility. Shipper then makes a decision based on delivery time, and the package is routed through the appropriate network. Shipper can also make both decisions about day and time for delivery (including delivery by desired appointment window of one, two or such defined time period in minutes or hours) in one step.

### CROSS-REFERENCE TO RELATED APPLICATIONS

The instant application claims benefit of provisional application Ser. No. 61/316,066 filed Mar. 22, 2010, the contents of which are herein incorporated by reference.

### BACKGROUND

1. Field of the Invention

The instant invention relates to shipper and carrier services. Particularly, the proposed system and method is designed to allow users of parcel services to select a service based on a mix and match of transit days and delivery times for better matching of a shipper's needs with carriers' services, resulting in greater customer satisfaction while lowering cost of service for carriers and thereby pricing for the shippers.

2. Description of the Related Art

The current parcel market is built on the legacy business methods of separate express market which relies on air networks and ground market, which use truck/rail networks for intercity transportation. While a parcel delivery service provider (herein “carrier”) may offer services with an integrated operational network for express and ground services, the industry still supports two separate markets with considerable overlap in operations, pricing, service levels, value proposition and customer oriented service features. There exists a need for a Virtual Integrated Parcel (VIP) service that is not encumbered by the legacy of the past practices of air/express and ground parcel markets but reflective of the current and future mode-neutral market trends.

Known in the prior art are systems and methods for optimizing shipment delivery costs and schedules. U.S. Pat. No. 7,233,907 teaches “partially scheduled time windows” which allow the user/recipient to modify the pre-set time of delivery so that the tradition 10:00 AM express delivery can be pushed to later in the day to align with already scheduled “later-in-the-day” deliveries by the same entity at the same location, thus reducing double-travel costs. U.S. Pat. No. 7,363,126 shows a process for varying the grids or delivery cells to optimize delivery costs. U.S. Pat. No. 5,631,827 and U.S. Pat. No. 7,647,233 discuss ways to optimize the parcel delivery process by: 1) allowing the shipper/user to access the rate servers of each major carrier ('827); or 2) allowing the shipper to select which supplier to use based on a presentation of all carrier data so that the shipper can choose the optimal provider in terms of cost ('233).

Despite describing optimization processes broadly related to time and cost, the parcel industry continues to essentially split air and ground business despite the operations themselves being integrated or having the potential to be integrated. This is especially true as major companies modify operations and networks in both air and ground markets. With such network changes it further becomes more difficult to mix and match shipper needs with carrier services. What would be desirable then is to provide a transportation mode-neutral method which allows the shipper to merely select a delivery day and time rather than also require a delivery mode selection and thereby defer to the carrier-established time. For instance if a user selects a time and day “x” for delivery, using the instant system and method the carrier could potentially use whatever mix of transportation, “y” or “z” or both, is most cost-efficient. Concurrently then the invention provides for the carriers to optimize the costs of the service because the only requirement is that the delivery time window be met. As above then, the proposed model is designed to allow users of parcel service (herein “shippers”) to select a service based on a mix and match of transit days and delivery times for better matching of shipper's needs with carriers' services, resulting in greater customer satisfaction while lowering cost of service for carriers and thereby pricing for the shippers, as follows.

### SUMMARY

The instant invention comprehends a method for matching and providing a shipper with a carrier service, comprising the steps of displaying an interface to the shipper wherein the shipper inputs both an origin zip code and a destination zip code. As a result of the inputs, a distance is then calculated between the origin zip code and the destination zip code, wherein a zone is assigned corresponding to a pricing matrix based on distance and number of transit days. The next step is presenting day options to the shipper such that the shipper may select the number of transit days, then displaying a first cost to the shipper based on such selection of the number of transit days. As a result of a selection by the shipper of the number of transit days with the first cost, one or more time options on the selected delivery day are presented to the shipper such that the shipper may select a delivery time. Next, displayed is a second cost to the shipper based on such selection of the delivery time. Accordingly, as a result of a selection by the shipper of the delivery time with the second cost, the carrier service is provided and displayed to the shipper, wherein the carrier service is matched to the shipper based on a mix of the transit days and a mix of the delivery time for better matching of shipper's needs with carriers' services while lowering cost of the carrier service. The instant invention also provides for the shipper to simultaneously select both preferred transit day and delivery time on the selected transit day to obtain rates for the various offered service levels with one input step and even obtain rates for a delivery time within a shipper specified delivery window.

### BRIEF DESCRIPTION OF THE DRAWINGS

FIG. 1 is a flow diagram representing the prior art system and method.

FIG. 2 shows a chart representing the prior art zone and day schedule as it relates to zone assignment for transport.

FIG. 3 shows a chart representing the prior art, pre-established express service time commitments.

FIG. 4 shows a chart representing the proposed deferred service program for zone assignment.

FIG. 5 shows a chart representing the proposed service time commitments.

FIG. 6 shows a chart representing a comparison of the current and proposed zone systems.

FIG. 7 is a flow diagram representing the instant system and method.

The flow charts and/or sections thereof represent a method with logic or program flow that can be executed by a specialized device or a computer and/or implemented on computer readable media or the like tangibly embodying the program of instructions. The executions are typically performed on a computer or specialized device as part of a global communications network such as the Internet. For example, a computer typically has a web browser installed within the CPU for allowing the viewing of information retrieved via a network on the display device. A network may also be construed as a local, ethernet connection or a global digital/broadband or wireless network or the like. The specialized device may include any device having circuitry or be a hand-held device, including but not limited to a cellular phone, smartphone, or personal digital assistant (PDA). Accordingly, multiple modes of implementation are possible and “system” as defined herein covers these multiple modes.

### DETAILED DESCRIPTION OF THE PREFERRED EMBODIMENT

The invention will now be described in detail in relation to a preferred embodiment and implementation thereof which is exemplary in nature and descriptively specific as disclosed. As is customary, it will be understood that no limitation of the scope of the invention is thereby intended. The invention encompasses such alterations and further modifications and applications as would normally occur to persons skilled in the art to which the invention relates. This detailed description of this invention is not meant to limit the invention, but is meant to provide a detailed disclosure of the best mode of practicing the invention.

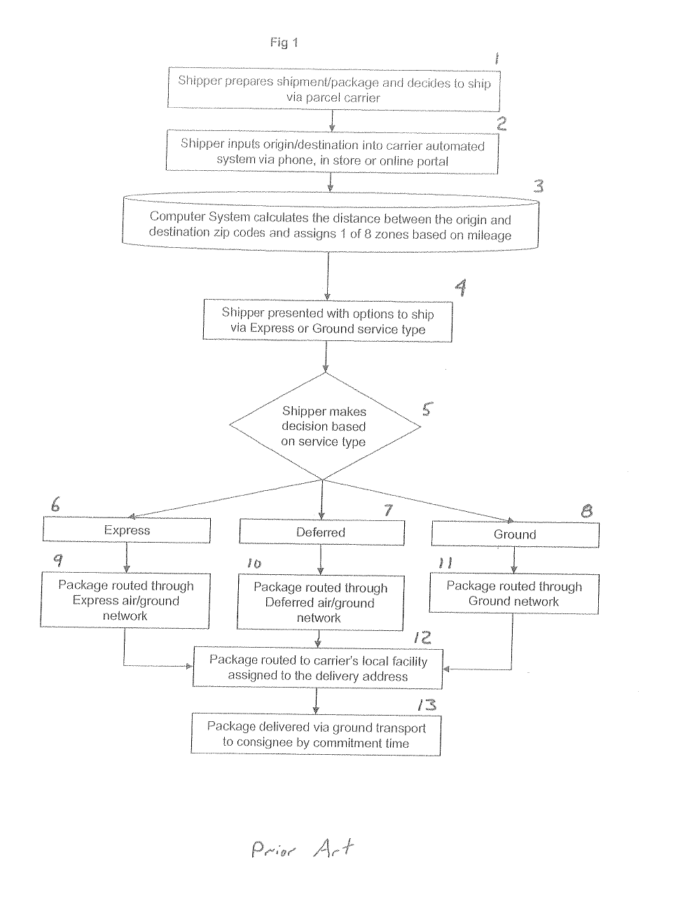

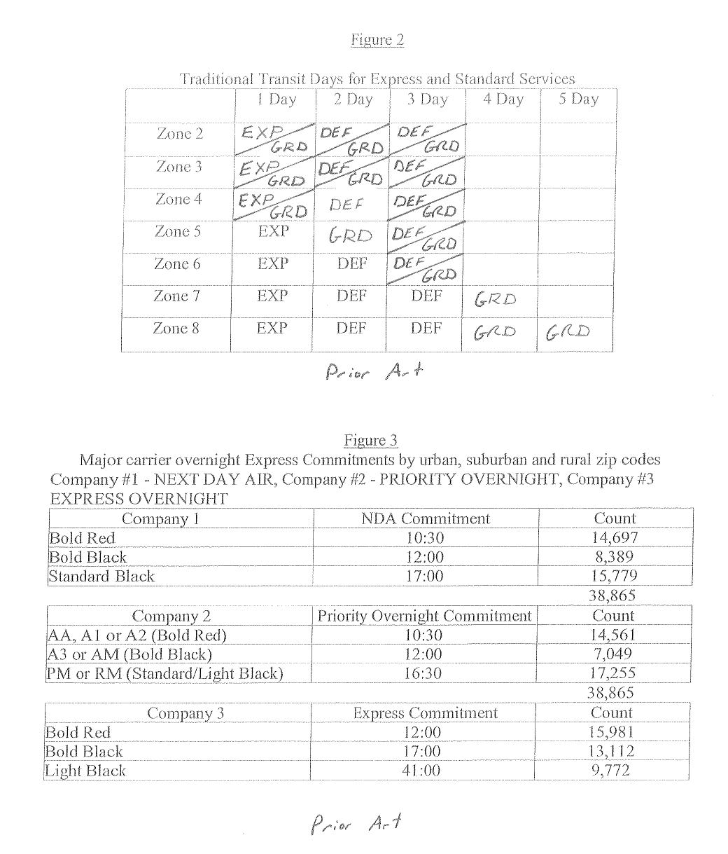

With reference then to FIGS. 1-3, shown is the prior system and method along with their typical attributes. The standard parcel delivery service provider (herein “carrier”) offers services with an integrated operational network for express and ground services despite the industry still supporting two separate markets. “Shippers” is defined herein as the user of the carrier service, desiring to transport their goods from one location to another, e.g. to a recipient who orders and receives the goods. Traditionally then, the shipper prepares a package or the like for shipment and decides to ship the goods via the parcel carrier 1. The shipper inputs the origin/destination into the carrier automated system via phone, in-store, or by way of a displayed online application or portal 2 (termed herein interface), for instance using a web browser over a global communications network such as the Internet. Important is that the carrier computer system calculates the distance between the origin and destination zip codes and assigns 1 of 8 zones based on mileage 3. See FIG. 2 for instance. Critical is that if the timing of the shipment matters, the shipper is presented main options to ship via Express or Ground service type 4. Thus, the shipper makes a decision based solely on service type 5 in reliance on the time frames pre-established by the carriers. The service types that make up the two main time-sensitive options include Express 6 and Ground 8, and Deferred 7 is an additional time-independent option. Deferred service generally utilizes a mix of air and ground network depending on the distance between origin and destination (often having two to three day transit time in the domestic US market), and thus tends to be slower than Express (which is overnight transit time in the domestic US market), which for large distances involves all air transportation, and faster than Ground, which for large distance utilizes all truck or truck/railroad based transportation, and can have transit time of one to eight days. Subsequent to service type selection the package is processed by being appropriately routed through the Express air/ground network 9, through the deferred air/ground network 10, or through the Ground network 11. The package is then routed to the carrier's local facility assigned to the delivery address 12 and subsequently delivered via ground transport to consignee by commitment time 13. Residential delivery is available for all services, but typically has a later commitment time than delivery to commercial addresses.

The current system of zip codes designated for local delivery commitments depending on the density and distance from major population areas is different for express and ground services. The express parcel market largely uses a system of bold red, bold black and light black. The distribution of zip codes within these three types of zip codes for one major carrier for example at one time is presented in FIG. 3. Of note is this current system of segmenting delivery time by type of zip code currently excludes a shipper from receiving an earlier delivery to bold black or light black destination zip code. The instant invention eliminates such restriction and expands the opportunities available to shippers with appropriate rate for the carrier to take interest in offering such service.

A largely unaccounted tot important factor in selecting parcel service is the transit days/time of day for delivery. The number of days is a function of the distance between the origin and destination address. The intercity transportation is accomplished by an, ground or a combination thereof based on the distance between the operating facilities of the carrier supporting the origin and destination city and the required transit days. The guaranteed time of day for local delivery is a function of the distance of the delivery address from the local facility of the carrier. Since local delivery is performed by ground transportation, the density of the destination address and the labor cost of delivering to such areas influence the delivery cost.

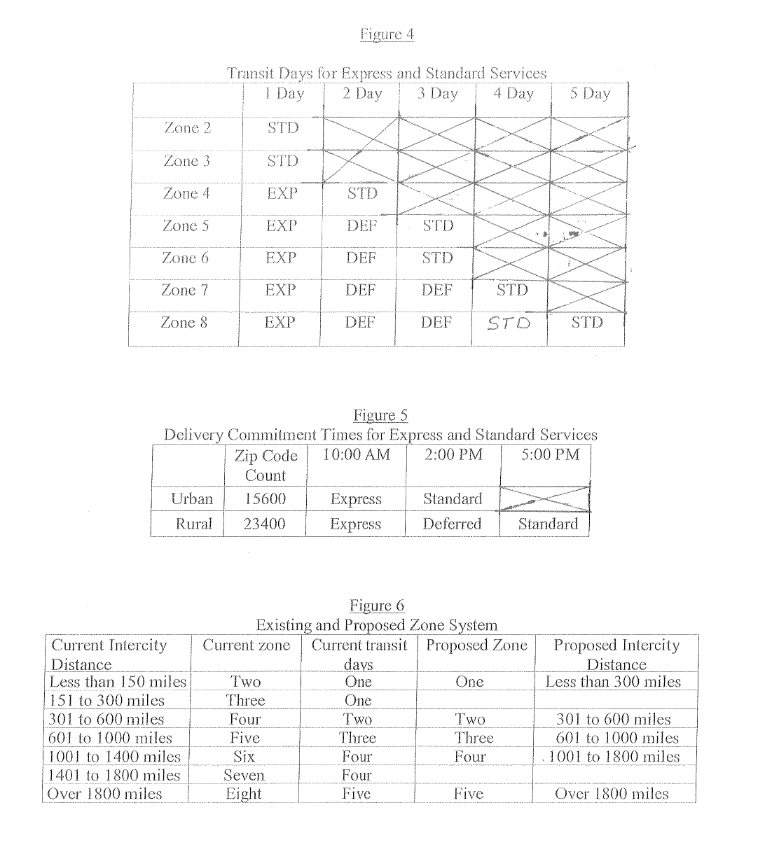

With reference then to FIGS. 4-7, in addition to selecting transit time in days, shippers need the packages delivered by a certain time of the day. Since the delivery cost is influenced by the urban and rural attribute of the applicable address, the herein proposed method incorporates preset local delivery time options based on the urban and rural nature of the destination zip code and provides for a premium price to cover the higher delivery cost to a rural or high risk delivery address. The proposed service matrix shown in FIG. 4 utilizes certain current terms for convenience and expediency but is a modification of the prior art zone structure, termed herein zone modification. The transit times in days for longer zones and distances using Express and Deferred service and those with over three (3) days thr delivery using standard service deal with the current structure of Express, Deferred and Ground services. However, the instant business method provides simplicity for shorter zone/distance and transit day services by removing overlapped Express/Deferred/Ground service offering.

For delivery in destination market or zip code, the standard services would be driven by the designation of the destination zip code. While the express parcel market has had this system for decades, ground parcel market introduced surcharge for delivery to rural zip codes in 1999 in recognition of higher delivery cost to such addresses.

Unlike the current parcel market that has two different systems and list of zip codes for urban and rural delivery areas, one for commitment times and another for rural surcharges, the instant system and method is zip code-independent relative to service type, offering one system of urban, suburban and rural zip codes that are same for express, deferred and standard delivery commitments. For standard service, the urban zip codes have an earlier commitment time of 2 pm with the rural zip codes having a later commitment time of 5 pm. Shippers have an option to obtain express delivery service for earlier delivery time at a premium price as illustrated in FIG. 5.

For urban delivery addresses, the instant system and method provides a premium option of express service, as an example, by 10:00 am or 10:30 am. However with a 5 pm delivery commitment for rural zip codes, shippers would have an additional option for 2 pm guaranteed delivery service (deferred) at a smaller premium and for morning guaranteed delivery service (express) for a higher premium. This method also permits parcel service providers to offer an early morning service with, for example, 8:00 am delivery service to both urban and rural zip codes.

While the instant system and method provides these commitment times for all addresses (commercial and residential), it is designed to permit different commitment times for residential addresses and even delivery by appointment period (one or two hour window) during the day of delivery. The residential addresses in urban zip codes could have a standard commitment time of 5:00 pm and the residential addresses in rural remote zip codes could have a later commitment time of 7:00 pm for example. These commitment times would provide operational efficiency and also meet the different needs of the commercial and residential customers.

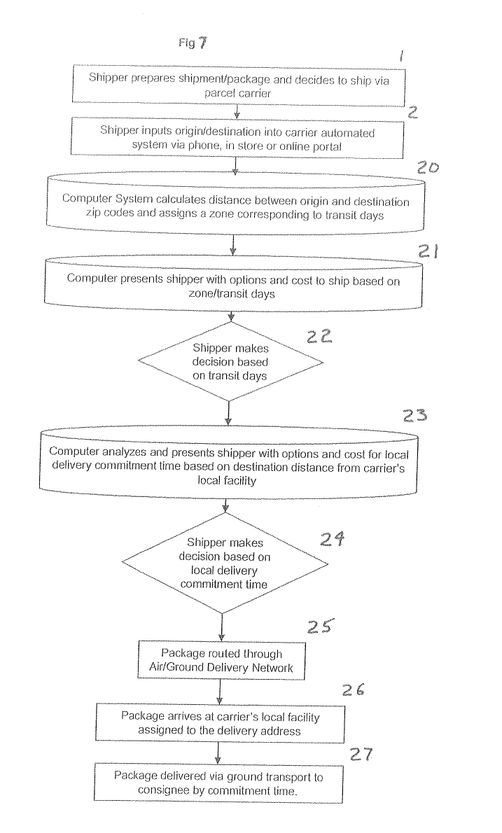

With reference to FIG. 6, the instant system and method includes utilization of electronic manifesting systems to allow customers to pick the day of delivery and the time of delivery. For customers looking to obtain a yet lower cost of service that results from a drop off at origin or a pickup location at destination, the system can present such option by offering locations within close proximity of origin address or destination address. Thereby, it also allows shippers to select an option for packages to be dropped off at a neighborhood business center for customer convenience.

Finally, the instant system and method allows for an efficient matrix-based pricing structure utilizing the system of zones shown also in FIG. 6. Provided is an approach involving fewer zones that are based on distance between origin and destination address of parcels, for example, five (5) zones instead of the current eight (8). This zone reduction critical in the instant method aligns delivery days with the proposed mix of air and ground network capabilities. This zone reduction also permits rate increases in shorter zones and creates the relationship between the zone used for pricing and the number of days used for guaranteed delivery service. For shippers, it facilitates the relationship between pricing zones and transit days for easier understanding of guaranteed delivery commitments by the carriers.

As it relates to the pricing system, the pricing system has the lowest base shipping charges for the standard service. The shippers can upgrade for faster transit time in days and earlier delivery by time of the day. Hence, a package weighing fifteen (15) pounds, the highest price would be for a package traveling across the country (current zone 8 and proposed zone 5) with a rural destination for next day delivery at the earliest time of the day available from the carrier. Conversely, the lowest price would be for the same package traveling the shortest distance (current zone 2 and proposed zone 1) with an urban destination for next day delivery by the latest time of the day available from that carrier.

All in all then with reference then FIG. 7 as it pertains to the implementation of the instant system and method, the shipper prepares a shipment, a package or the like and decides to ship the goods via the parcel carrier 1. The shipper inputs the origin/destination and whether the destination is a residential or commercial location into the carrier automated system via phone, in-store, or by way of online application or portal 2 (termed herein “interface”), for instance over a global communications network such as the Internet. The system subsequently calculates a distance in miles between origin and destination zip codes using the matrix presented in FIG. 6 and assigns a zone and corresponding transit days 20. The computer then presents shipper with options and cost to ship based on zone/transit days 21 (termed herein “day options”). Shipper makes the day option selection decision based on transit days 22. Computer analyzes and presents shipper with options and a first cost for local delivery commitment time based on destination distance from carrier's local facility 23 and residential/commercial status as determined by zip code. The shipper next makes a decision based on local delivery commitment time 24 (termed herein “time option”), such that the shipper may select a delivery time and a second cost can be displayed taking into account the delivery time. Package is routed through Air/Ground Delivery Network 25. Package arrives at carrier's local facility assigned to the delivery address 26. Package delivered via ground transport to consignee by commitment time 27. Accordingly, critically different from prior systems is that the instant invention provides for the shipper to make selection of transit days and delivery time on the selected day at the same time and be presented with the price for that combination of day and time of day.

As a result of the above selections and costs associated therewith, the users of this system and method have thus selected a carrier service based on mix and match of transit days and delivery times for better matching of shipper's needs with carriers' services while lowering cost of service for carriers. This system also eliminates the overlap in express, deferred and ground services and builds confidence in shippers that they are not paying a premium price for a non-premium service. The invention further provides for a mix and match of delivery service also by transit days and delivery time of day. For example, using the current methodology, a shipper could select Express for transit days and Express, Deferred or Ground for delivery time, or select Deferred for transit days and Express, Deferred and Ground thr time of delivery on the Deferred transit day, and finally, select Ground for transit day and then Express, Deferred or Ground for time of delivery on Ground transit days. The invention also provides for delivery by appointment window (a period of one to two hours as per the operational capability and pricing offered by the specific carrier) on the day of delivery.

I claim:

1. A method for matching and providing a shipper with a carrier service, comprising the steps of:
displaying an interface to said shipper wherein said shipper inputs both an origin zip code and a destination zip code;
as a result of said inputs, calculating a distance between said origin zip code and said destination zip code, wherein a zone is assigned corresponding to a number of transit days;
presenting day options to said shipper such that said shipper may select said number of transit days;
displaying a first cost to said shipper based on such selection of said number of transit days;
as a result of a selection by said shipper of said number of transit days with said first cost, presenting one or more time options to said shipper such that said shipper may select a delivery time;
displaying a second cost to said shipper based on such selection of said delivery time;
as a result of a selection by said shipper of said delivery time with said second cost, providing and displaying to said shipper said carrier service, wherein said carrier service is matched to said shipper based on a mix of said transit days and a mix of said delivery time for better matching of shipper's needs with carriers' services while lowering cost of said carrier service.

2. The method of claim 1, wherein said shipper further inputs an indication of whether a destination at said destination zip code is a residential location or a commercial location.

3. The method of claim 1, wherein said shipper is allowed to make a decision about both said delivery time and said delivery day on one step.

4. The method of claim 1, wherein said delivery time is an appoint lent window.

5. The method of claim 1, wherein said zone is modified for express and standard services, thereby forming modified deferred services.

6. The method of claim 1, wherein said shipper is provided with an option to obtain express delivery service for early delivery time at a premium price.

7. The method of claim 1, further comprising the step of providing the same commitment time independent of said origin zip code and said destination zip code.

8. The method of claim 1, further comprising the step of reducing a number of said zones.

9. The method of claim 8, wherein said zones are reduced to five zones.

10. The method of claim 8, wherein a matrix-based pricing system is provided to match a price to said zone as a result of such reduction of said number of said zones.

11. A system for matching and providing a shipper with a carrier service, comprising:
means for accepting inputs from a shipper for both an origin zip code and a destination zip code;
means for allowing said shipper to select a number of transit days corresponding to an a zone assigned as a result of said inputs, said zone assigned by calculating a distance between said origin zip code and said destination zip code;
means for displaying a first cost to said shipper based on such selection of said number of transit days;
means for allowing said shipper to select a delivery time as a result of a selection by said shipper of said number of transit days with said first cost;
means for displaying a second cost to said shipper based on such selection of said delivery time;
means for providing and displaying to said shipper said carrier service as a result of a selection by said shipper of said delivery time with said second cost, wherein said carrier service is matched to said shipper based on a mix of said transit days and a mix of said delivery time for better matching of shipper's needs with carriers' services while lowering cost of said carrier service.

12. The system of claim 11, further comprising modified deferred services wherein said zone is modified for express and standard services.

13. The system of claim 12, further comprising a matrix-based pricing system which reflects such modification of said zones.
